(19) United States
(12) Patent Application Publication
(10) Pub. No.: US 2024/0224983 A9
(43) Pub. Date: Jul. 11, 2024

(54) GLUE TRAP TRAY WITH MULTIUSE HANDLE AND METHOD FOR EUTHANIZING A CRAWLING PEST

(71) Applicant: Anthony Jeremiah Bayne, Lomita, CA (US)

(72) Inventor: Anthony Jeremiah Bayne, Lomita, CA (US)

(21) Appl. No.: 18/210,650

(22) Filed: Jun. 15, 2023

Related U.S. Application Data
(60) Provisional application No. 63/417,595, filed on Oct. 19, 2022.
(60) Provisional application No. 63/445,893, filed on Feb. 15, 2023.

(51) Int. Cl. A01M 23/00

(52) U.S. Cl. CPC A01M 23/005

(57) ABSTRACT

A glue trap includes a tray and a multiuse handle that is integral to the tray, and is a unitary, one-piece construction with the tray. In an alternate embodiment, the trap includes an attached movable handle. Moreover, the handle can be used to strike the glue trap and a captured crawling pest against a hard surface in a method to humanely euthanize the pest before disposing of it.

### BACKGROUND OF THE INVENTION

### Field of Invention

The invention relates to pest control, and more specifically to an improved glue trap for humanely euthanizing a captured pest.

### Description of Related Technology

A “glue trap” and a “glue board” are traps used to catch rats, mice, and other crawling pests. They may be constructed of paperboard, cardboard, fiberboard, or plastic. Both are commonly rectangular shaped and include a top surface area that is covered by an adhesive layer (commonly referred to as “glue”). This adhesive area traps pests that crawl onto it.

The adhesive area of a glue trap is surrounded by low walls to create a pen. The walls end in a narrow rim that is either higher than the adhesive area (a “high rim”), or substantially level with the adhesive area (a “low rim”).

Glue traps are usually sold in pairs, with each pair snapped together face-to-face by mating male-to-female attachment points. Pairs are snapped together at the rim when the trap has a high rim, or at the top of the walls that surround the pen area when the trap has a low rim.

Unlike a glue trap, glue board traps have no walls. However, some glue boards have sections that can be folded to partially cover the adhesive area. The adhesive area of a glue board is covered with a non-stick sheet that is removed before use.

The problems that will be discussed apply to a glue trap and a glue board, and each will be referred to collectively as a “glue trap”, or “glue traps”, hereinafter, unless specified otherwise. Also, examples will be discussed involving a “rat”, but it should be understood to include other crawling pests (e.g., mice).

In related art (CA 2430632), Riad M. Anani discloses a holding device for “an adhesive object” that a user can grip to “take the initiative to target flying insects.” In addition to requiring assembly (i.e., attaching an adhesive object to the device for use), another problem with it, and other glue traps, is that they are not an “instant kill” trap and do not provide a means, or instructions, on how to euthanize (i.e., humanely kill) a captured rat.

Glue trap instructions merely advise users to dispose of the trap and a captured rat into a trash receptacle. This encourages a user to allow a rat to die of stress and/or dehydration. This is a cruelty problem and has caused many jurisdictions to outlaw, or greatly limit, the use of glue traps.

Another problem with glue traps is that their narrow rim makes it easy for a user to get glue on his/her fingers and difficult to hold onto when disposing of a live rat. A user that finds a captured rat thrashing on the adhesive area will pinch the trap's rim at the point farthest away from the rat to avoid getting bit or scratched. This minimal trap control increases the risk of the user dropping the trap and having the rat dislodge and escape. To avoid these risks, a user will sometimes leave the rat on the trap to die before disposing of it. Again, a cruel death for the rat.

Yet, another problem with glue traps is that since they are light weight, a rat whose upper body is free of the trap's adhesive may drag it away, making the rat and the attached trap difficult to find. When the rat dies hidden away, it results in an inhumane death for the rat. Some glue trap makers provide “putty” to prevent a rat from dragging a glue trap away, but the putty may leave a residue that a user has to clean up after disposing of the trap.

Another problem of glue traps is the way they are packaged and displayed. Glue traps are packaged in a cardboard box, or a plastic bag, and hung from the package's reinforced hole on a display rack hook. The packaging material is not used to capture a rat and so is superfluous and results in needless expense.

Therefore, there remains a need to address the peculiar challenges in the prior art to provide a glue trap that can be used to humanely euthanize a captured rat, that cannot be dragged away, and displayed without wasting packaging material.

### BRIEF SUMMARY OF THE CERTAIN INVENTIVE ASPECTS

To overcome the aforesaid problems of inhumanely disposing of a live rat caught on a glue trap, preventing a rat from dragging a glue trap away from the trap's original placement, and providing an efficient way of packaging and displaying a glue trap for sale, disclosed is an improved glue trap with a multiuse handle and method for humanely euthanizing a crawling pest.

Without limiting the scope of this invention as expressed by the claims that follow, its more prominent features will now be discussed briefly. After considering this discussion, and particularly after reading the section entitled “DETAILED DESCRIPTION OF THE INVENTION”, one will understand how the features of this invention provide advantages that include the improved handling and humane euthanizing of a pest caught on a glue trap.

Although the following description of exemplary embodiments will be presented in the context of a captured “rat”, other crawling pests (e.g., mice, snakes) are included.

In a preferred embodiment, the invention includes a glue trap, comprising a glue trap tray, an adhesive on a top surface of the glue trap tray, and a handle that is a unitary, one-piece construction with the glue trap tray.

In an alternate embodiment, the invention includes a glue trap, comprising a glue trap, that further includes a glue trap tray, an adhesive on a top surface of the glue trap tray; and an attached handle that is moveable from a first position to a second position. The handle in the second position is preferably fixable to keep it in place when euthanizing a captured pest.

In another alternate embodiment, the invention comprises a board for a glue board trap and a handle that is a one-piece, unitary construction with the board. The board and handle are preferably of an equal thickness and/or density. The handle is preferably opposite a length side of the glue board so that in use, the longest segment of the board's adhesive area will be placed in a rat's path when the length side, opposite the handle, is placed against a wall. This alternate embodiment may be a production blank for glue board trap. A manufacturer/user can apply their desired adhesive directly onto the adhesive area.

In yet another alternate embodiment, the invention comprises a mini-glue trap (including a mini-glue board). The mini-glue trap includes a mini-glue trap tray and handle of a one-piece, unitary construction. The mini-glue trap is preferably small enough to fit on one half of the top surface of a snap bar rodent trap. For example, if the snap bar trap is a rat trap, then the length of the mini-glue trap may be 2 inches long×1.5 inches wide to fit on the half of the trap where the bait pedal is located. The handle includes a hole that can be opened and closed to attach it to the top surface of a snap bar rodent trap. For example, the hole may have a perpendicular slit to twist open and closed to attach it to a bait pedal staple. When a rat becomes attached to the trap, and tries to pull free, it will jostle and release the snap bar. Further, the mini-glue trap will delay the rat for the snap bar to kill it.

In yet another alternate embodiment, the invention includes a method to humanely euthanize a crawling pest, including the steps of a user grasping a handle of a glue trap after a crawling pest has become attached to the glue trap. Next, striking the crawling pest against a hard surface while grasping the handle of the glue trap to euthanize it. Next, disposing of the crawling pest and trap when the crawling pest is dead.

In yet another alternate embodiment, the invention includes a package of two glue traps, each including an integral one-piece handle, that are joined face to face. The glue traps are separated by a user who pulls the respective handles away from each other. The user can then layout the separated traps for a rat. Separating the traps by handles allows the user to avoid getting glue on his fingers as they may when separating prior art glue traps.

In yet another alternate embodiment, the invention includes a glue trap package that utilizes a trap's multiuse handle to display the package. The glue trap package includes a tray and a handle of a unitary, one-piece construction, wherein the handle further includes a hole. The package further includes an opening in its top to allow the handle to protrude from the top to hang the package from a display hook.

The invention, now having been briefly summarized, may be better visualized by turning to the following drawings wherein like elements are referenced by like numerals.

To the accomplishment of the above and related objects, the present invention may be embodied in the form illustrated in the accompanying drawings. However, the drawings are illustrative only, and changes may be made in the specific construction(s) illustrated and described that are within the scope of the claims.

Although, the invention is described herein in terms of various exemplary embodiments and implementations, the various features, aspects, and functionality described in one or more of the individual embodiments are not limited in their applicability to the embodiment with which they are described. Instead, they can be applied, alone or in various combinations, to one or more of the other embodiments of the invention, whether such embodiments are explicitly described and whether such features are presented as being a part of a described embodiment. Thus, the breadth and scope of the present invention should not be limited by any of the above-described exemplary embodiments.

The presence of broadening words and phrases such as “one or more,” “at least,” “but not limited to”, or other like phrases, shall not be read to mean that the narrower case is intended, or required, where such broadening phrases may be absent.

The objects and features of the present invention will become more fully apparent from the following description and appended claims, taken in conjunction with the accompanying drawings. Understanding that these drawings depict only typical embodiments of the invention and are not to be considered limiting of its scope, the invention will be described and explained with additional specificity and detail using the accompanying drawings.

### BRIEF DESCRIPTION OF THE DRAWINGS

FIG. 1 shows a perspective view of a glue trap including a high rimmed tray with an integral, one-piece, multi-use handle in accordance with the present invention.

FIG. 2 shows a top view of the glue trap in accordance with the present invention.

FIG. 3 shows a front view of the glue trap in accordance with the present invention.

FIG. 4 shows a rear view of the glue trap in accordance with the present invention.

FIG. 5 shows a side view of the glue trap tray in accordance with present invention;

FIG. 6 shows a perspective view of an alternate embodiment of a glue trap, including a low rim tray with an integral one-piece multiuse handle that acts as an extension of the trap's base to prevent a rat from flipping the trap.

FIG. 7 shows a perspective view of an alternative embodiment of a glue trap, including a trap with an integral one-piece multiuse handle extending from a width side of the tray's rim.

FIG. 8 shows a perspective view of an alternate embodiment of a glue trap, including an attached moveable handle fixed in a second position.

FIG. 9 shows a top view of the alternative embodiment in FIG. 8 in accordance with the present invention.

FIG. 10 shows a front view of the alternative embodiment in FIG. 8 in accordance with the present invention.

FIG. 11 shows a side view of the alternative embodiment in FIG. 8 in accordance with the present invention.

FIG. 12. shows a front view of the alternative embodiment in FIG. 8 with an attached moveable handle in the first position.

FIG. 13 shows a side view of the alternative embodiment in FIG. 8 with an attached moveable handle in the first position.

FIG. 14 shows a top view of the alternate embodiment of a glue trap, including two movable handles that are storable proximate to a tray's length side in a first position.

FIG. 15 shows a perspective view of a board for a glue board trap, including an integral one-piece multiuse handle.

FIG. 16 shows a top view of the board in FIG. 15 for a glue board trap.

FIG. 17 shows a front view of the board in FIG. 15 for a glue board trap.

FIG. 18 shows a side view of the board for a glue board trap.

FIG. 19 shows a perspective view of a mini-glue trap, including a mini-glue trap tray and opened split holed handle, of a unitary one-piece construction, that allows it to be attached to the surface of a snap bar rodent trap.

FIG. 20 shows a top view of the mini-glue trap tray in FIG. 19 attached to the staple of a snap bar trap (snap bar assembly omitted).

FIG. 21 shows a perspective view of a glue trap kit, including a separated handle and a glue trap tray.

FIG. 22 shows a perspective view of the kit in FIG. 21 in a joined state.

FIG. 23 shows a front view of a glue trap hanging in a package from a display hook.

FIG. 24 shows a flowchart illustrating a method to humanely euthanize a pest/rat caught on a glue trap that includes a tray and integral one-piece multiuse handle; and

FIG. 25 shows an illustration of a user humanely euthanizing a rat, according to the method in accordance with the present invention.

### DETAILED DESCRIPTION OF THE INVENTION

The following detailed description is directed to certain specific embodiments of the invention. However, the invention can be embodied in a multitude of diverse ways as defined and covered by the claims. In this description, reference is made to the drawings wherein like parts are designated with like numerals throughout. As used herein, the term “glue trap” includes both a “glue trap” and a “glue board”, unless specified otherwise.

The present invention solves the aforesaid problems by providing a glue trap that includes a glue trap tray and a multiuse handle that are a unitary, one-piece construction to support a method of humanely euthanizing a pest, as will be discussed below.

The multiuse handle is preferably at least as rigid as the glue trap tray rim from which it extends, but it may be more rigid or less rigid, and/or extend from a location other than the glue trap tray's rim (e.g., from an exterior wall, a structure attached to the wall and/or rim, etc.). The multiuse handle may be made more rigid by using different and/or additional material(s), or by reinforcing it with a structure projecting from the tray (e.g., a buttress from an exterior tray wall). A hole in the multiuse handle may be used to hang the glue trap on a display hook, and in use, as a location for a string to thread through and tie down the glue trap to prevent it from being dragged away by a rat.

The glue trap tray may include walls that are a unitary construction with the glue trap tray, and surround part, or all of the adhesive area, to create a pen area. When a wall partitions the adhesive area from the rim, the rim will be substantially level with the adhesive area (i.e., a “low rim”), so that in use, the rim's bottom surface will rest on whatever surface the trap is placed. Alternatively, the rim may be higher than the adhesive area. (i.e., a “high rim”).

In a preferred embodiment, the rim (low or high) is a unified, one-piece construction with a tray wall. When the tray includes a wall that ends in a rim, the multiuse handle is preferably formed as an extension of the rim. The handle is contemplated to be gripped by a user to accelerate a trap against a hard surface to euthanize a rat that has been captured on the adhesive area.

However, with or without a rim, the handle may connect and/or extend from a different part (e.g., a hinge structure), or parts (e.g., rim and wall), of the trap. A manufacturer can use additional material, different material, or a combination of materials and/or structures (e.g., a buttress), as well as different processes (e.g., forming, molding, etc.) to create the desired handle rigidity (e.g., more rigid than the rim, or tray).

In a preferred embodiment, the handle will extend away from the tray in an approximate perpendicular angle to create the maximum distance between a user's hand that is grasping the handle's end and the tray. Likewise, when the handle is moveable into a second position it preferably extends away from the tray in an approximate perpendicular angle. In an alternate kit embodiment, when a removably attachable handle is joined to the tray, the handle may join at an approximate perpendicular angle to the tray.

In an alternate embodiment, the multiuse handle may be less rigid than the rim when the handle is used as a tether to tie the trap to a location. For example, when the handle's hole is an elongated slit that is large enough, or can be stretched large enough, to thread the entire tray through to tie the handle around an object that a rat cannot move (e.g., a table leg).

Since rats often run along a room's baseboards, it is effective for a user to place a length side of a glue trap against a room's baseboard to maximize the distance the rat must travel when running over the trap's adhesive area. A rectangularly shaped glue trap may include a handle that extends from the center of the glue trap tray's first length side and is opposite to a second parallel length side. The second length side may be placed against a wall/baseboard to position the greatest amount of adhesive in a rat's path. Also, the handle being centered on a first length side will give the user the best chance of having a rat captured away from the handle when the rat is caught coming onto a width side of the trap.

In a preferred embodiment, the handle will include a length to accommodate an adult's grip. For example, a handbreadth's length of approximately four inches or greater. Alternatively, the handle may be at least as long as the width of the tray. However, the handle may be shorter or longer, depending on the manufacturer's shipping concerns (e.g., the longer the handle, the less traps that will fit inside of a shipping container when the handle is not moveable).

When the glue trap tray has a low rim and a handle of a one-piece unified construction, the handle will lay substantially flat on whatever surface the tray is placed. A benefit of a low rim handle is that the handle will act like an outrigger, or extended base, to prevent a rat from flipping the trap over, and/or dragging the trap away from its original placement when it tries to escape.

A hole in the tray's handle can be used to secure the glue trap to an object incapable of being moved by a rat. For example, a user can thread one end of a string through the hole and tie a knot around the handle and tie the other end of the string to a table leg.

Additionally, the hole in the handle can be used to display a trap (or a pair of traps) for sale, by hanging it on a display hook, when the glue trap's packaging allows the handle (s) to protrude from the top of a package. In this way, a manufacturer will save money on packaging by using the trap as part of the package. Indeed, when the glue trap is sold in pairs of two, they may be snapped together face-to-face, to align their handle holes. Labeling (e.g., instructions, bar codes, etc.) can be attached to the bottom of a pair of trays. This can be done either by having information directly printed, etched, etc. on the bottom surface of the trays, or by affixing labels with information to the bottom of the trays.

In alternate embodiment, the handle may be removably attachable to a glue trap tray as part of a kit. In this embodiment, the tray may have multiple locations to attach a handle, so that a user can attach the handle at the point farthest away from a trapped rat when it comes time to euthanize and dispose of it.

In yet another alternate embodiment, the trap's handle is not of a unitary construction with the tray, but instead is attached to the tray in such a way that the handle is moveable from a first (stored) position to a second (extended/in use) position. For example, the handle may be connected to the tray via a structure, such as a hinge or rivet, to allow the handle to fold around, or next to, the body of the tray, so that a glue trap can be conventionally packaged (i.e., no part of the glue trap protrudes from a package). When the trap is unpackaged, the handle may then be unfolded into an extended position that is preferably fixable.

The moveable handle may be made of wire, plastic, or other suitable material, or combination of them. In this alternate embodiment, the tray may include a plurality of handles. For example, the trap may have two handles joined to the tray's rim that fold underneath the rim in a first position to allow the trap to be conventionally packaged and may be manually fanned out into a second position to use to strike the trap against a hard surface to euthanize a captured rat. In a preferred embodiment, the movable handle will be fixable in a second position to allow a user to better control the trap and captured rat. However, the handle need not be fixable.

In yet another alternate embodiment, the invention includes a miniature glue trap (mini-glue trap), with an integral handle of a unified one-piece construction. The handle includes a hole with a perpendicular slit in it, to allow it to be opened and closed to attach the trap to the top surface of a snap bar rodent trap component (e.g., a pedal, a staple, etc.). In this way a second way is provided for a rat to release the catch that holds the snap bar in place (the first way is for a rat to depress the snap bar trap's bait pedal). A rat that attempts to pull its paw free of the mini-glue trap will jostle the catch free and release the snap bar killing the rat. Further, the mini-glue trap/board will delay the rat's escape when the snap bar is released, increasing the probability that the snap bar will instantly kill the rat. In this embodiment, the mini-glue trap becomes a “euthanizing multiplier”, the very opposite of prior art glue traps that are targeted as “inhumane”.

These and other features, aspects and embodiments of the invention will be described in more detail below.

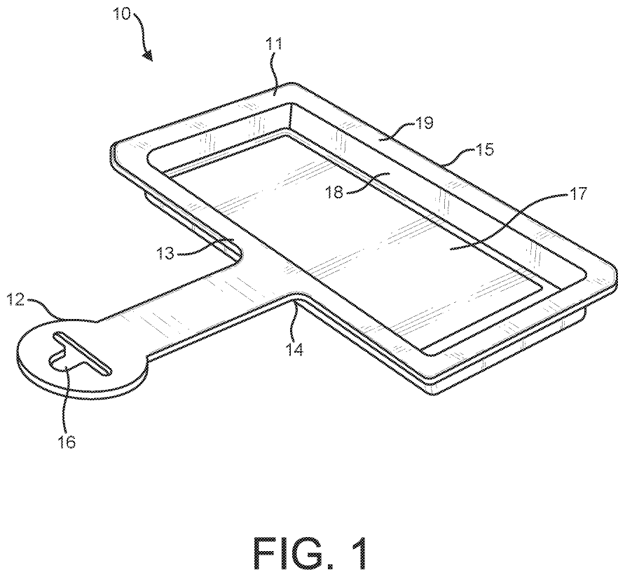

FIG. 1 is a perspective view of a glue trap 10. The glue trap 10 comprises a glue trap tray 11 and a multiuse handle 12 of a unitary, one-piece construction. The multiuse handle 12 is preferably made of the same material as the glue trap tray 11. In an alternative embodiment, the handle 12 may be made of a different material than the tray 11, or a combination of materials. The material may be plastic, fiberboard, cardboard, paperboard, or other suitable material. The material may include recycled material(s).

The multiuse handle 12 preferably extends from the center of a first length side 13 of the tray 11 in an approximate perpendicular angle 14. Alternatively, the multiuse handle 12 may protrude from another part of the glue trap tray 11 (e.g., a wall's 18 exterior). Further, the multiuse handle 12 may be opposite a second length side 15 of the tray 11 (e.g. when the trap 10 has a pair of parallel sides, such as a rectangle, trapezoid, or parallelogram shape), so that the second length side 15 may be placed against a wall's base/baseboard, in a suspected rat's path to maximize the distance a rat must travel across the trap's 10 surface.

The multiuse handle 12 includes a hole 16 configured to receive a hook to hang the glue trap 10 on a display. In addition to using the hole 16 to hang the trap 10, the hole 16 may be used to thread a string through, to tie the trap 10 to an object that a rat cannot move. For example, the user may tie a string from the hole 16 to a table leg (not shown).

The trap 10 includes an adhesive area 17 on the top surface of the tray 11 that is covered by a layer of adhesive, that may be surrounded by one or more walls 18 that end in a rim 19. The adhesive will have a strength (as measured by a tensile strength test, a shear strength test, or a peel strength test) sufficient to hold a struggling rat (e.g., a large brown rat or Indian bandicoot rat). In an alternate embodiments, the trap 10 may be sold without adhesive 17 (for a user to add their own), or with a weaker adhesive.

When the rim 19 is higher than the adhesive area 17, the tray 11 has a high rim 19, and when the rim 19 is substantially level with the adhesive area 17, the tray 11 has a low rim 19.

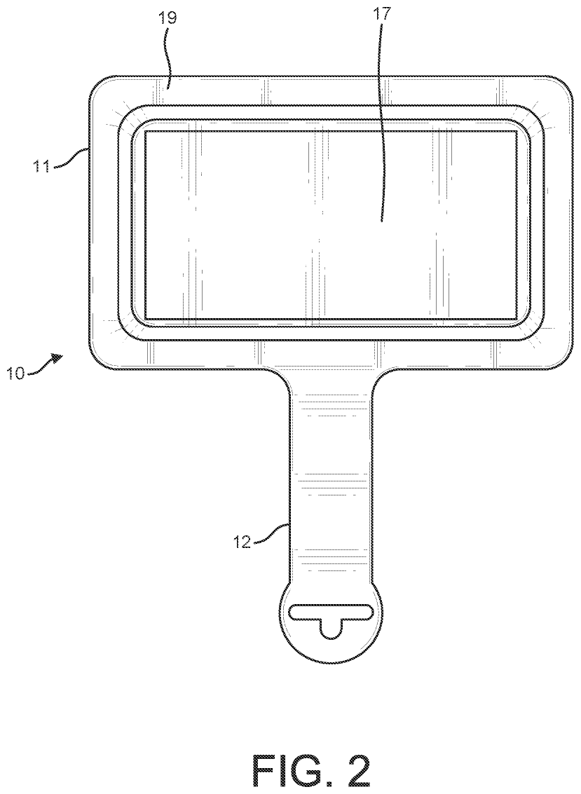

FIG. 2 is a top view of FIG. 1. The tray 11 has a high rim 19 and a multiuse handle 12 with a length approximately equal to the tray's 11 width. However, in an alternate embodiment the multiuse handle 12 may be longer, or shorter than the tray's 11 width to accommodate an adult's hand (e.g., a handsbreadth length of approximately 4 inches). An adhesive area 17 is on a top surface of the tray 11.

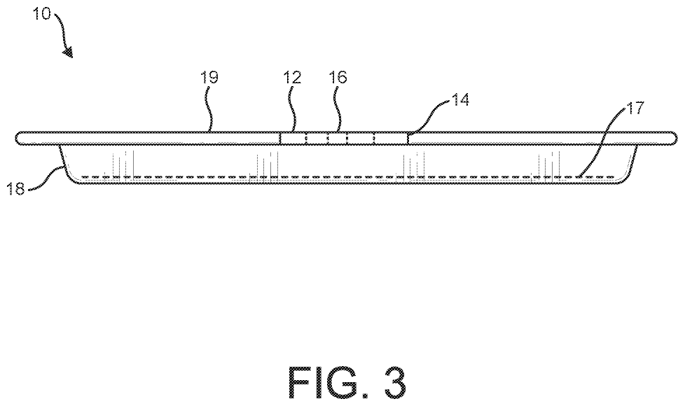

FIG. 3 is a front view of FIG. 2, including an integral, one-piece, multiuse handle 12 with a hole 16. The multiuse handle 12 extends outwardly from a rim 19 at an approximate perpendicular angle 14 and is substantially level with the rim 19. The rim 19 is higher than the adhesive area 17 that is surrounded by the trap's 10 wall 18, and so the trap 10 has a high rim 19.

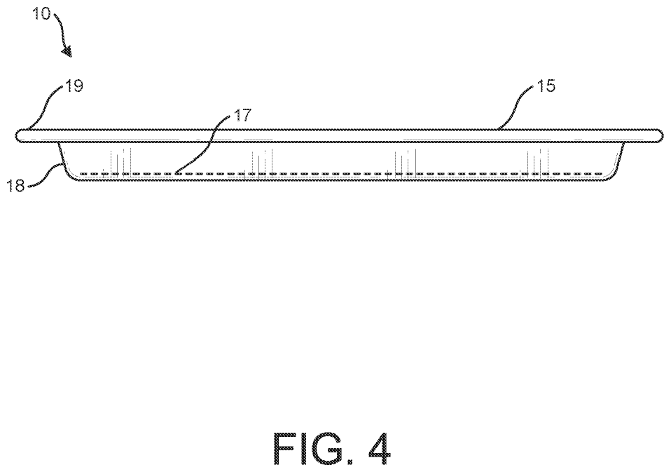

FIG. 4 is a rear view of FIG. 2, including a second length side 15 that is parallel to a first length side 13 of the trap 10. The trap's 10 second length side 15 may be placed against a wall's baseboard to position the longest portion of the adhesive area 17 in a rat's suspected/known path.

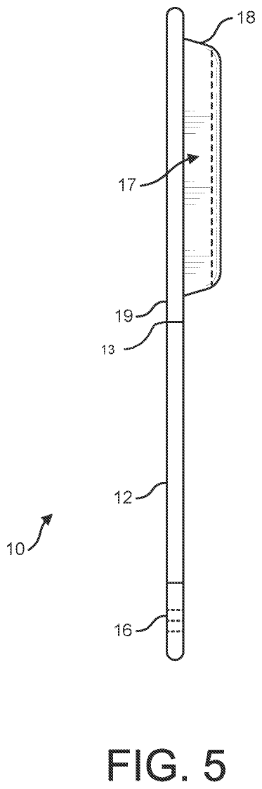

FIG. 5 is a side view of FIG. 2, where the multiuse handle 12 includes a hole 16 and extends from the trap's 10 first length side 13 and rim 19. The rim 19 is higher than the adhesive area 17 that is surrounded by wall(s) 18.

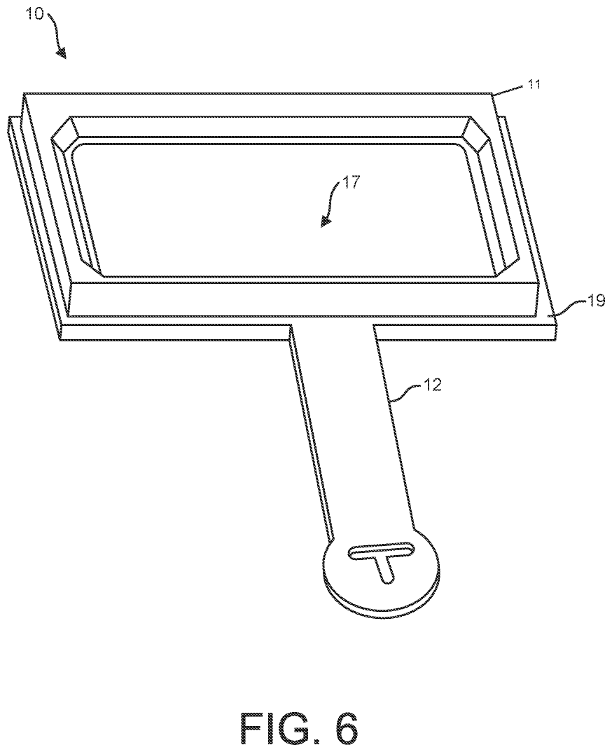

FIG. 6 is a perspective view of an alternative embodiment of a glue trap 10, including a low rim 19. The multiuse handle 12 is of a unitary, one-piece construction with the tray 11 and rim 19, and is substantially level with the adhesive area 17 and rim 19. In use, the multiuse handle 12 rests on a surface (e.g., a floor) where the trap 10 is placed. The handle 12 effectively extends the base of the trap 10 to act like a canoe's outrigger, to prevent the trap 10 from being flipped over by a struggling rat. Further, the friction caused by the handle's 12 bottom surface being in contact with a floor makes it difficult for the trap 10 to be dragged away by a rat when the rat's upper body is free of the adhesive area 17.

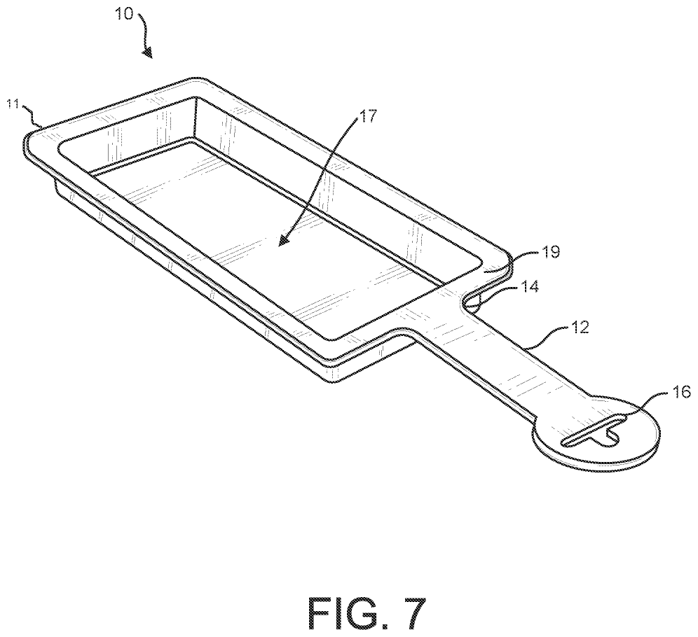

FIG. 7 is a perspective view of an alternative embodiment of a glue trap 10 with a tray 11 and multiuse handle 12 of a unitary, one-piece construction, including a hole 16. The handle 12 extends from the tray's 11 width side rim 19 at an approximate perpendicular angle 14. The adhesive area 17 is lower than the rim 19. In an alternate embodiment, the handle 12 may extend from the tray 11 at a greater or lesser angle, extend from a corner of the tray 11, etc.

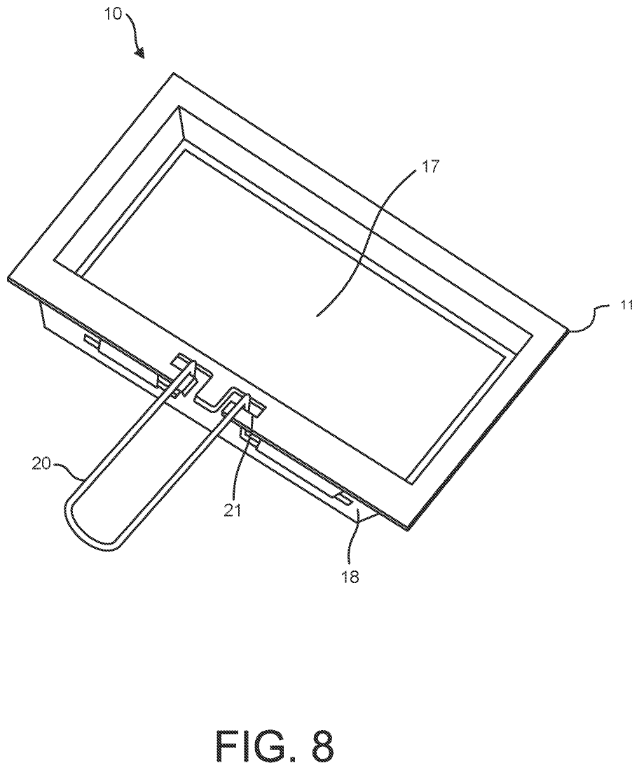

FIG. 8 is a perspective view of an alternate embodiment of a glue trap 10, including a tray 11 and an attached moveable handle 20 that is in a second position 21. The movable handle 20 extends away from the trap 10, so that a user can avoid accidentally contacting the adhesive area 17, a captured rat (not shown), or use the handle 20 to euthanize the captured rat.

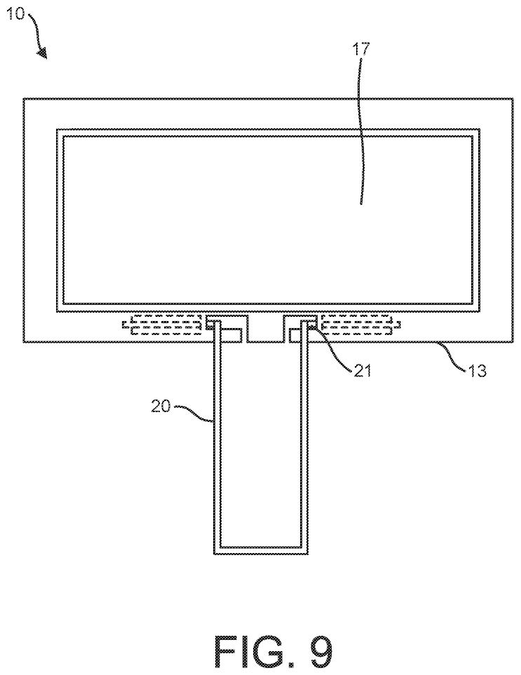

FIG. 9 is a top view of the trap 10 in FIG. 8, with the movable handle 20 in a fixed second position 21, extending away from a first length side 13 of the trap 10 and adhesive area 17. The handle 20 is moveable to a fixed second position 21 to easily handle a captured struggling rat (not shown).

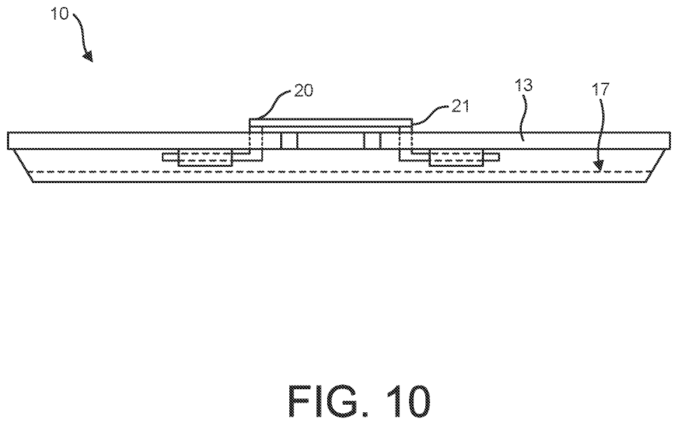

FIG. 10 is a front view of the trap 10 in FIG. 9, with a moveable handle 20 in a fixed second position 21, that extends away from the tray's 11 first length side 13 and adhesive area 17.

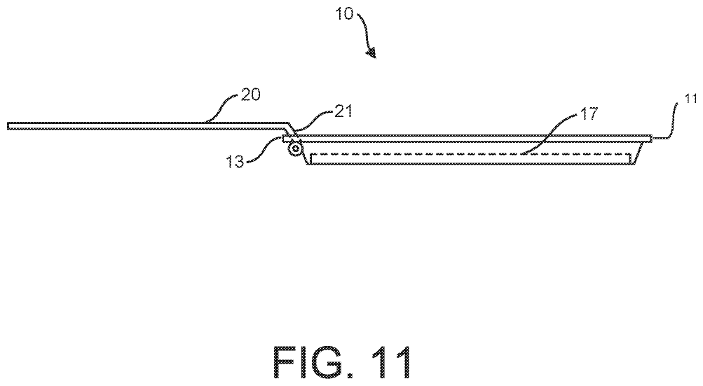

FIG. 11 is a sideview of the trap 10 in FIG. 9, with a movable handle 20 in a fixed second position 21, that extends away from the tray's 11 first length side 13 and adhesive area 17.

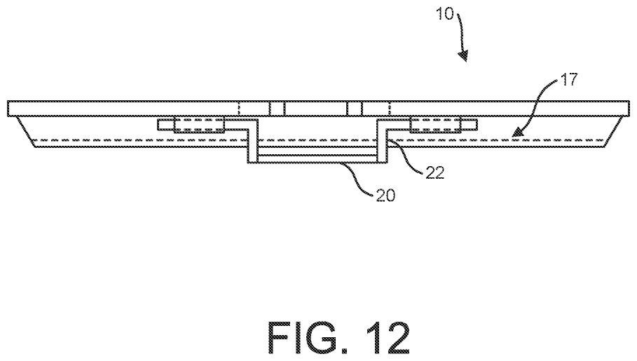

FIG. 12. is a front view of the trap 10 in FIG. 9 with a movable handle 20 in the first position 22, folded under the trap's 10 adhesive area 17, so that the trap 10 can be packaged without the handle 20 protruding from a package.

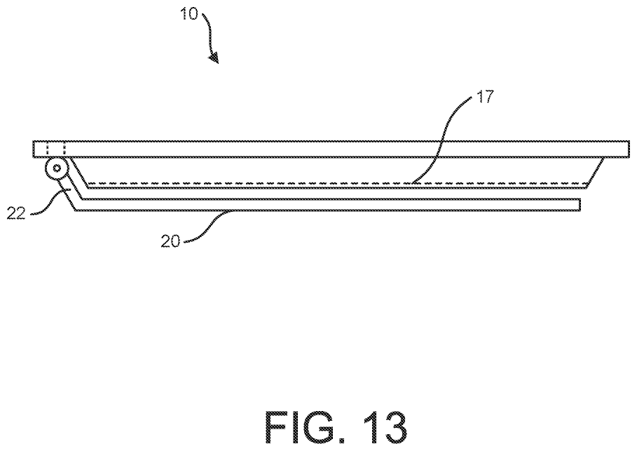

FIG. 13 is a side view of FIG. 12 with a moveable handle 20 folded under the trap's 10 adhesive area 17 in a first position 22.

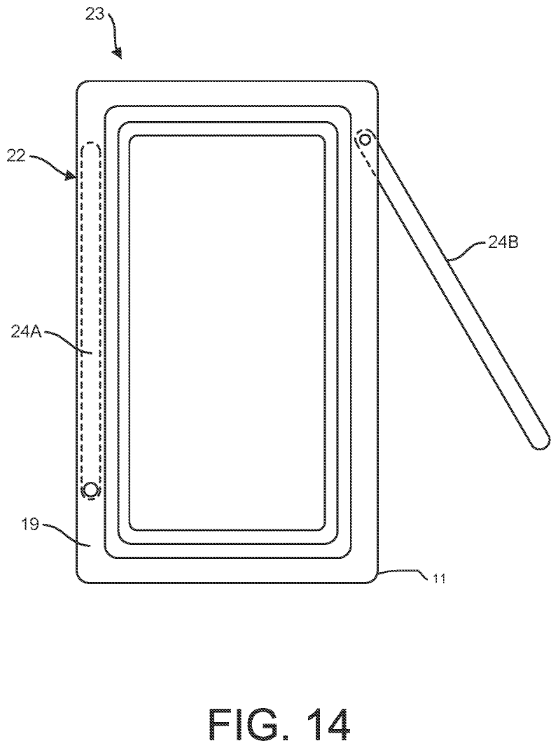

FIG. 14 is a top view of an alternate embodiment of a dual handled glue trap 23, with two moveable handles 24A and 24B that store proximate to the tray 11 of dual handled trap 23, under the rim 19 in a first position 22 (as shown by 24A) and may be manually extended outwardly (as shown by 24B) for a user to grip and strike the dual handled trap 23 against a hard surface to euthanize a captured rat. The handles 24A & 24B may be storable under the rim 19 to allow a second trap (not shown) to be joined face to face with the first trap 23 in a package.

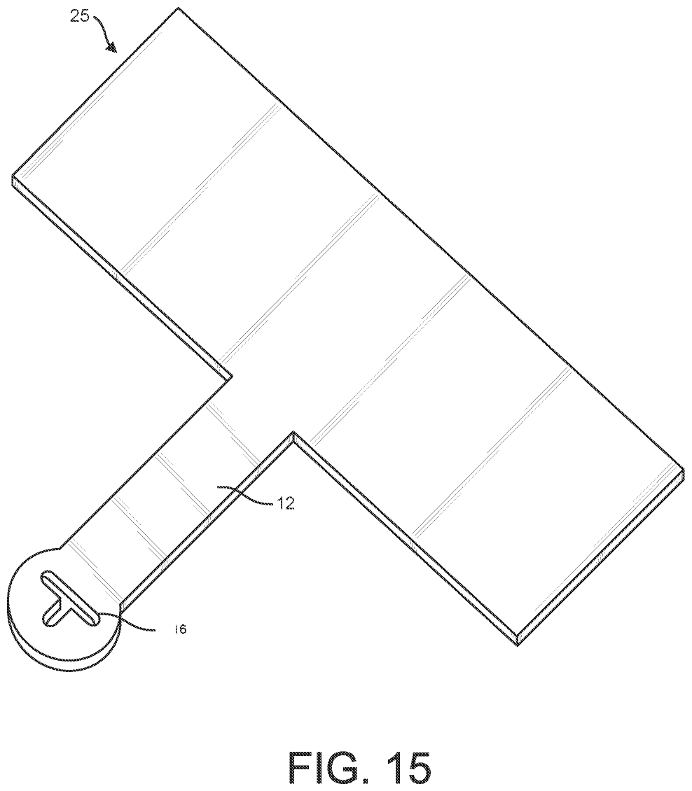

FIG. 15 is a perspective view of a board 25 (e.g., an unfinished production blank) and a multiuse handle 12 of a unitary, one-piece construction for a glue board trap. The handle 12 and board are preferably of the same thickness and density as the tray, so that it can be cut/formed from a single piece of paperboard, or other suitable material (e.g., cardboard) and includes a hole 16. In an alternative embodiment, the glue board 25 includes a glue board trap (i.e. a glue board and handle with a unitary, one-piece construction and an adhesive on a top surface that is of a strength to catch a crawling pest).

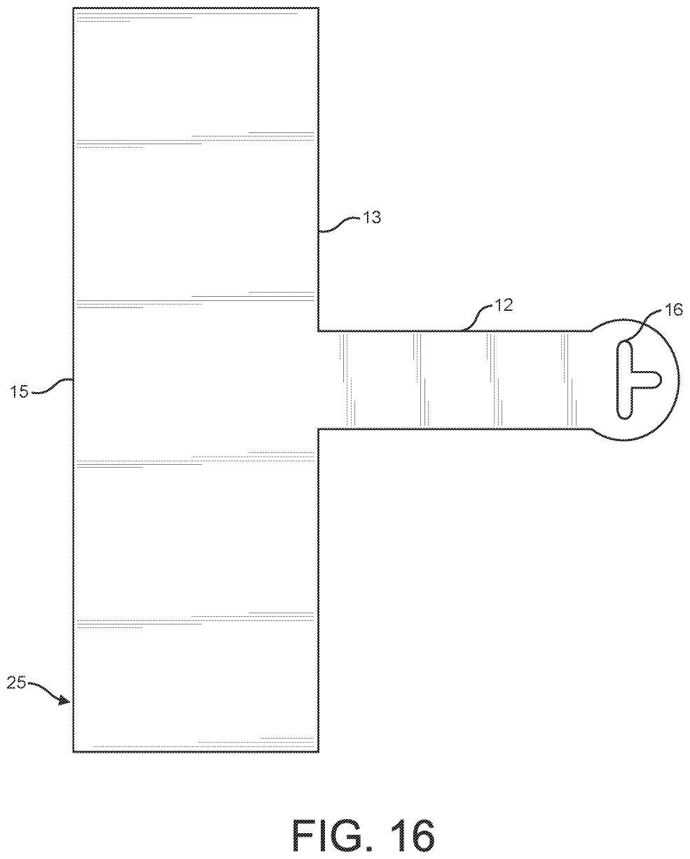

FIG. 16 is a top view of the board 25 in FIG. 15. Including a board 25 and a multiuse handle 12 of a unitary, one-piece construction that includes a hole 16. The handle 12 preferably extends from the first length side 13 of the board 25 opposite a second length side 15. In an alternate embodiment, the handle 12 may extend from any side, or corner, of the board 25. Further, in an alternate embodiment the board 25, may include more than one handle 12, or one or more movable handles (not shown).

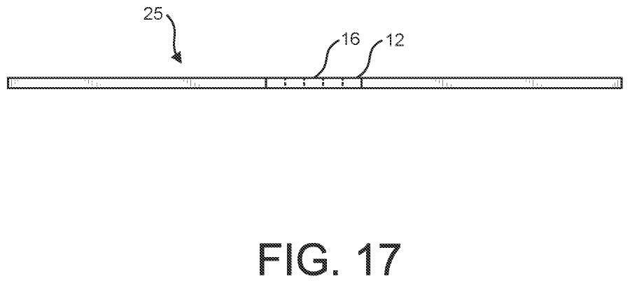

FIG. 17 is a front view of FIG. 16. The board 25 includes a multiuse handle 12 of a unitary, one-piece construction. The handle 12 includes a hole 16 to hang the board 25 from a display hook (not shown), or tie the board 25 to an object that a rat cannot move (e.g. a table leg, not shown).

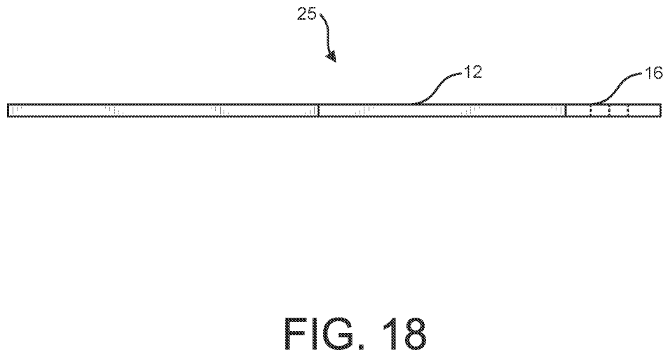

FIG. 18 is a sideview of FIG. 16. The board 25 and multiuse handle 12 are of a unitary, one-piece construction. The handle 12 and board 25 are preferably of the same thickness (as shown), and/or density. Alternatively, they may be of different thicknesses and/or densities. In a preferred embodiment, the handle 12 will have a length to accommodate an adult's grip. For example, the handle 12 may be 4 inches long, or longer. However, the handle 12 can be longer or shorter than 4 inches. A longer handle 12 will create more space between a user's hand and a captured rat but may reduce the number of units that may fit in a shipping container. The handle 12 includes a hole 16 to receive a display hook.

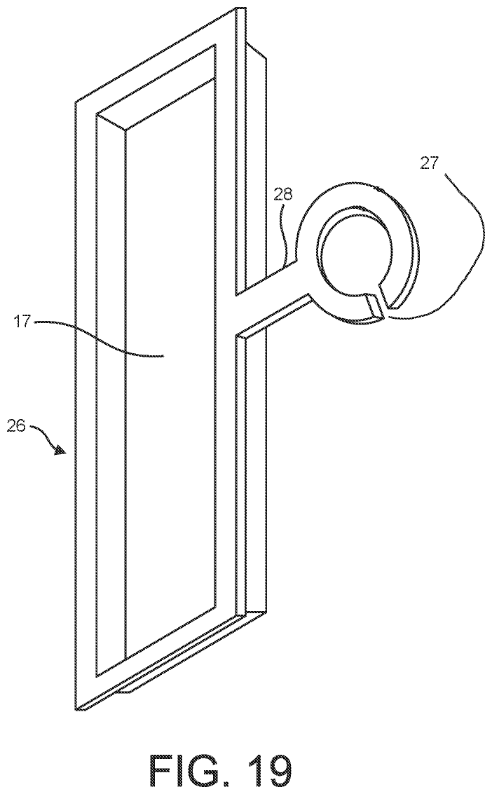

FIG. 19 is a perspective view of an alternate embodiment of a mini-glue trap 26, including a split holed handle 28 and an adhesive area 17. A split 27, in the split holed handle 28 allows the mini-glue trap 26 to attach to the surface of a snap bar rodent trap (not shown).

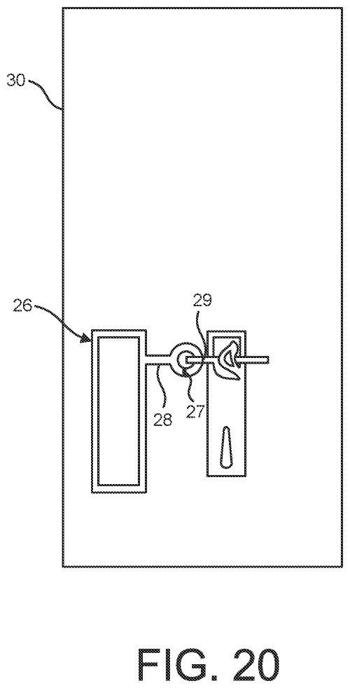

FIG. 20 is a top view of the mini-glue trap 26 in FIG. 19 attached to the staple 29 of a snap bar trap platform 30 by the split holed handle 28. The split 27 may be manually twisted open and closed to attach the mini-glue trap 26 to a snap bar trap.

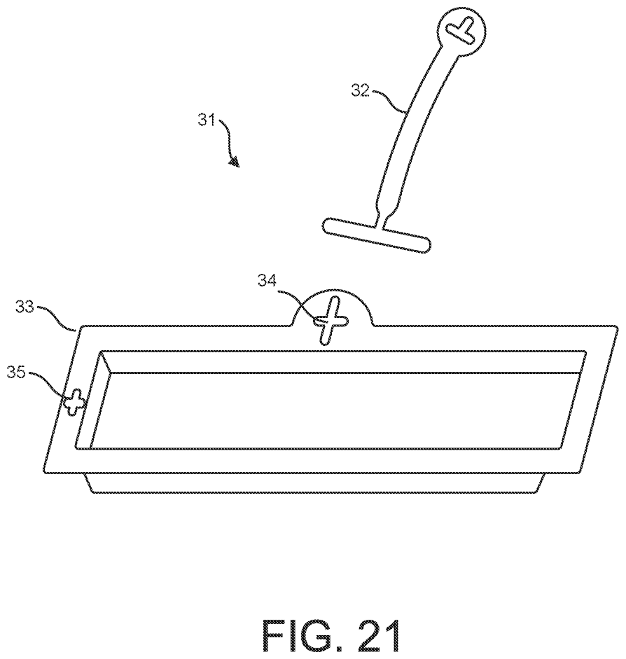

FIG. 21 is a perspective view of an alternative embodiment glue trap kit 31, including a separated handle 32 and glue trap kit tray 33. In this embodiment, the handle 32 is separated from the tray 33 and is connected by a user to euthanize and dispose of a rat. The glue trap kit tray 33 may have one or more holes 34 to attach the handle 32 to when it is time to euthanize and dispose of a rat. When the glue trap kit tray 33 has more than one hole 35, the user can attach the handle 32 at a point furthest away from a captured rat.

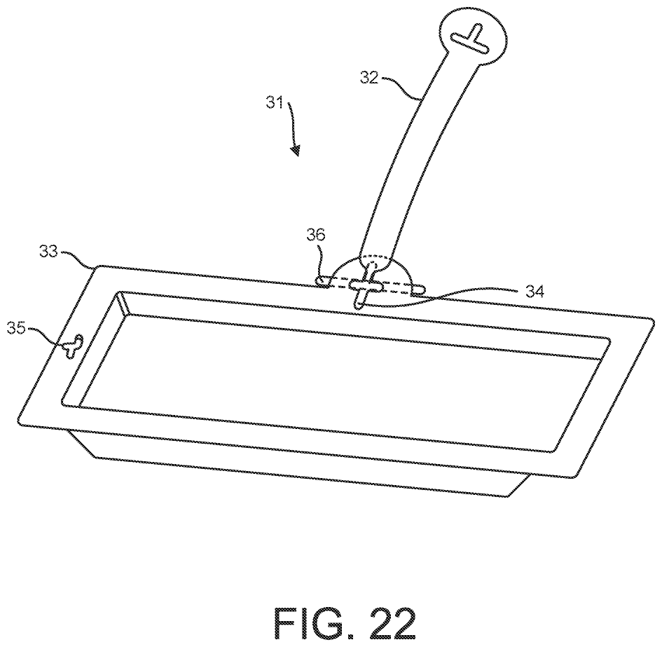

FIG. 22 is a perspective view of the kit 31 in FIG. 21 with the handle 32 joined to the glue trap kit 31 tray 33. The handle 32 end 36 is inserted through a hole 34 of the glue trap kit tray 33.

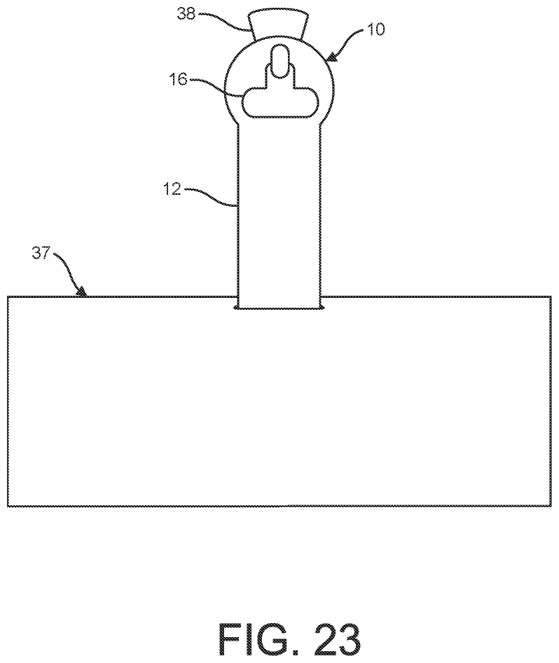

FIG. 23 is a front view of a glue trap package 37 alternative embodiment hanging from a display a hook 38 by a hole 16 in the multiuse handle 12 that is protruding from the top of the glue trap package 37. As used herein, a display hook 38, includes a slatwall hook, gridwall hook, retail spinner display rack, wire gridwall display rack, pegboard hook, etc., and other yet to be used means of displaying an item for sale.

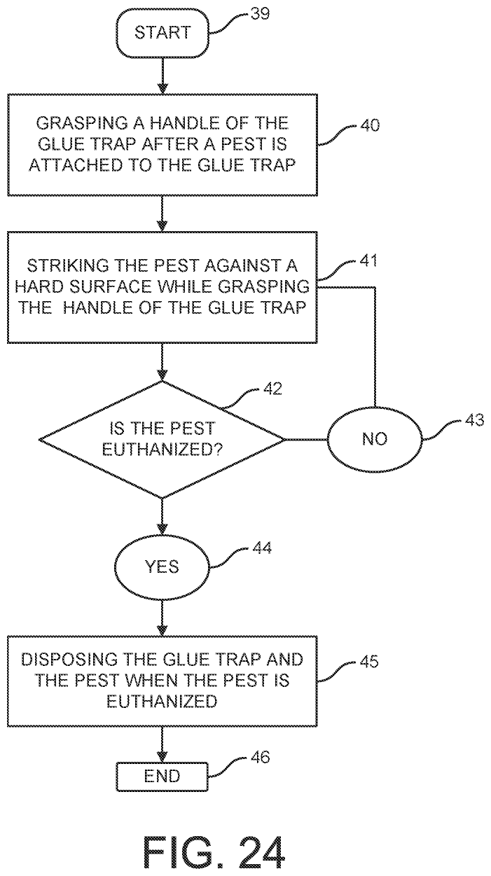

FIG. 24 is a flow diagram illustrating an exemplary method for a user to humanely euthanize a crawling pest (e.g., a rat) caught on a glue trap 10 that includes a tray 11 and a multiuse handle 12 in accordance with certain embodiments of the invention. The method starts at block 39 which represents a user positioning a second length side 15 of a glue trap 10 against a baseboard.

The method next proceeds to block 40 where the user grasps the trap's 10 multiuse handle 12 after a crawling pest has been captured on the adhesive area 17 of the trap's 10 tray 11. The method next proceeds to block 41 where the user strikes the tray 11 (and crawling pest) against a hard surface (e.g., the inside of a garbage can) to euthanize (i.e., kill) the rat/pest.

The method then next proceeds to block 42 where the user determines if the crawling pest is euthanized (i.e., dead). If “no” at block 43 the rat is still alive, the method repeats block 41, until the answer is “yes” at block 44. Once the rat is euthanized, the method next proceeds to block 45 where the user disposes of the dead crawling pest and the trap 10 into a trash receptacle. Where the method then ends at block 46.

By providing a method FIG. 24 to euthanize a pest using a glue trap 10 that incorporates a tray 11 and a multiuse handle 12 of a unitary construction (FIG. 1), a moveable handle (FIG. 8), or a mini-glue trap 26 accoutrement to a snap bar trap, a glue trap 10 can be used humanely to capture and kill a rat unlike prior art glue traps.

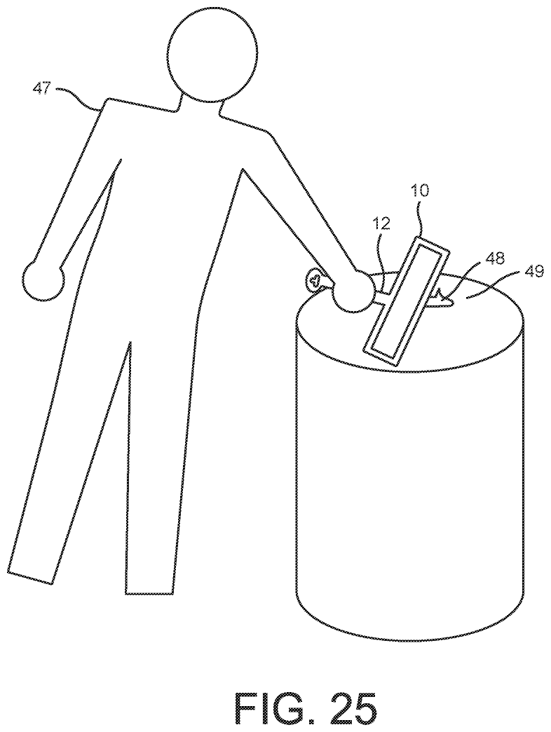

FIG. 25 is an illustration of a user 47 humanely euthanizing a rat 48 (i.e., a crawling pest) that has been captured on a glue trap 10. The user 47 is shown using the trap's 10 multiuse handle 12 of a unified one-piece construction to strike the rat 48 against the inside of a trash can 49 (e.g., a hard surface) euthanizing the rat 48.

The disclosed invention teaches a new glue trap, and alternate embodiments, that unlike prior art glue traps, may be used to humanely euthanize a trapped rat, or other crawling pest. Many alterations and modifications may be made by those having ordinary skill in the art without departing from the spirit and scope of the invention.

Therefore, it must be understood that the illustrated embodiments have been set forth only for the purposes of examples and that they should not be taken as limiting the invention as defined by the following claims. For example, notwithstanding the fact that the elements of a claim are set forth below in certain combination, it must be expressly understood that the invention includes other combinations of fewer, more, or different ones of the disclosed elements.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted, and what incorporates the essential idea of the invention.

I claim:

1. A glue trap, comprising:
a glue trap tray,
an adhesive on a top surface of the glue trap tray; and
a handle that is a unitary, one-piece construction with the glue trap tray.

2. The handle of claim 1, wherein the handle extends from a length side of the glue trap tray.

3. The handle of claim 2, wherein the handle extends perpendicularly from the length side of the glue trap tray.

4. The glue trap tray of claim 1, wherein the tray further includes a first and a second length side that are parallel to each other.

5. The handle of claim 1, wherein the handle includes a length that is at least as long as a width of the tray.

6. The handle of claim 1, wherein the handle is substantially level with the adhesive.

7. The glue trap tray of claim 1, further including a glue board trap.

8. The handle of claim 1, further including a hole.

9. The hole of claim 8, further including a slit extending perpendicularly from the hole towards an outside edge of the handle.

10. The glue trap of claim 1, wherein the handle is useable to humanely euthanize a captured rodent by gripping the handle to strike the glue trap tray against a hard surface.

11. A glue trap, comprising:
a glue trap, including a glue trap tray,
an adhesive on a top surface of the glue trap tray; and
a handle that is movable from a first position to a second position.

12. The handle of claim 11 further being attached on a length side of the glue trap of claim 11.

13. The first position of claim 11, including a handle storage position.

14. The handle of claim 11, wherein the handle in the second position extends the handle away from the glue trap.

15. The second position of claim 14 being fixable.

16. The glue trap of claim 11, including a second handle that is attached on an opposite side to the first handle's location.

17. A board for a glue board trap, comprising:
a board for a glue board trap; and
a handle of a one-piece, unitary construction.

18. The board and handle of claim 17 being of an equal thickness.

19. The handle of claim 17, wherein the handle is opposite a length side of the glue board.

20. A method to euthanize a crawling pest caught on a glue trap, comprising the steps of:
grasping a handle of a glue trap after a crawling pest has become attached to the glue trap;
next, striking the crawling pest against a hard surface while grasping the handle of the glue trap;
euthanizing the crawling pest by striking the pest against a hard surface while grasping the handle of the glue trap; and
next, disposing of the trap and attached crawling pest when the pest has been euthanized.
